(19) United States
(12) Patent Application Publication
(10) Pub. No.: US 2010/0063676 A1
(43) Pub. Date: Mar. 11, 2010

(54) Vehicle-installation person detection apparatus and crash absorption apparatus incorporating the person detection apparatus

(75) Inventor: Yosuke Ito, Oobu-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/584,358

(22) Filed: Sep. 3, 2009

(30) Foreign Application Priority Data
Sep. 8, 2008 (JP) 2008-230031

(51) Int. Cl. B60R 21/34

(52) U.S. Cl. 701/36

(57) ABSTRACT

A person detection apparatus controls activation of a crash absorption device such as an external airbag of a vehicle, whereby when the vehicle is about to collide with a detected object, a judgement is made as to whether the object is a person. If the object is judged to be other than a person, activation of the crash absorption device is inhibited. It is rendered easier or more difficult for an object to be judged as being a person, in accordance with whether or not the vehicle is operating in an environment with a relatively high probability that persons will be present.

### CROSS-REFERENCE TO RELATED APPLICATIONS

This application is based on and incorporates herein by reference Japanese Patent Application No. 2008-230031 filed on Sep. 8, 2008.

### BACKGROUND OF THE INVENTION

1. Field of the Invention

The present invention relates to a person detection apparatus for installation on a vehicle, for detecting a person located in the path of the vehicle. The invention further relates to a crash absorption apparatus, utilizing the person detection apparatus, for alleviating an impact which occurs when the vehicle collides with a person.

2. Description of Related Art

Types of apparatus are known for reducing the impact which occurs when a vehicle collides with a person, by automatic actuation of equipment of the vehicle. In particular, types of crash absorption apparatus for vehicle installation are known, whereby when it is detected that the vehicle is about to collide with an object in its path, the vehicle hood is opened to an extent whereby an opening is formed between the hood and the interior of the hood, and whereby an airbag (external airbag) is expanded outward through the opening, for thereby absorbing the impact of the collision. Such a crash absorption apparatus is described for example in Japanese patent first publication No. 2003-226211.

With such an apparatus, it is desirable that the external airbag be deployed only when the vehicle in which the crash absorption apparatus is installed (the latter vehicle referred to in the following as the local vehicle) is about to collide with a person, and it is not possible to avoid the collision. Deployment of the airbag is not necessary in the event of a collision between the local vehicle and an object which is not a person, such as another vehicle, and such unnecessary deployment is to be avoided as far as possible, since it is not possible to re-use an airbag once it has been deployed.

### SUMMARY OF THE INVENTION

For the above reason, it is an objective of the present invention to provide a crash absorption apparatus having a discrimination function whereby, when the local vehicle is about to collide with a detected external object (referred to herein as a target object) located in the motion path of the local vehicle, the target object can be reliably distinguished as being either a person or some object other than a person. Such a person detection apparatus is applicable to a system in which parameters (such as height, etc.) relating to the external appearance of an external object can be acquired. That information is used to judge the probability that a target object is a person, and if the probability is above a specific threshold value then activation of a crash absorption device (such as an actuator of an external airbag) is enabled, while if the probability does not attain the threshold value then activation of the crash absorption device is inhibited.

In that way, unnecessary activation of a crash absorption device or devices can be avoided.

More specifically, to achieve the above objective according to a first aspect, the invention provides a person detection apparatus having a person probability computation function, for calculating (with respect to a target object) a person probability which expresses a degree of matching between the target object parameter and a predetermined person parameter or parameters that is/are characteristic of the typical external appearance of a person. Such an apparatus further includes an environment detection function, for detecting at least one environmental condition relating to the environment in which the target object parameter is detected (i.e., the current environment at the time of detecting the target object parameter) and a person judgement function. The term “environment” as used herein is to be understood as including the traffic circumstances in which the local vehicle is currently operating. The person judgement function serves to compare the person probability with a threshold value, and to judge that the target object is a person if the person probability exceeds the threshold value. In particular, such a person detection apparatus is characterized by a compensation function, for adjusting either the threshold value (i.e., adjusting a fixed predetermined threshold value), or the calculated person probability, in accordance with the detected environmental condition. This compensation is performed such that, the greater the likelihood that a person may be present in the environment of the local vehicle, the more readily will that target object be judged to be a person (i.e., with this being achieved by reducing a predetermined threshold value, or increasing the calculated person probability).

An apparatus or apparatuses for implementing the target object parameter detection function and the environment detection function may be provided separately from the person detection apparatus, or all of the functions may be implemented by a single apparatus. For example, environment information may be acquired from a vehicle navigation apparatus. The detected target object parameter or parameters can consist for example of the height and/or width, or external shape of a target object, or a value or values from which these can be derived. The actual height of a target object may be obtained based on the height of the object with respect to a camera image frame in which the target object appears, or based that image information in conjunction with the distance of the target object as measured by a radar apparatus.

Altering of the threshold value or of the person probability in accordance with environment conditions may be executed in a stepwise manner, or in a continuous manner.

Furthermore (for a specific detected target object), the environment detection function and the compensation function may be configured to each operate only once, prior to operation of the person judgement function with respect to that target object, or (if the person judgement function is configured to make repetitive judgements concerning a target object) the environment detection function and the compensation function may be executed at arbitrarily determined timings, or executed repetitively.

Preferably, such a person detection apparatus comprises a computer and a data storage device having a control program stored therein beforehand, with functions including the compensation function, etc., being implemented by the computer, operating under the control program.

From a second aspect, such a person detection apparatus may be adapted to be installed in a vehicle (the local vehicle). In that case, the person probability computation function is applied to a target object for which there is a danger of collision with the local vehicle, i.e., a body that is detected as being at a position coinciding with a direction of motion of the vehicle and close to the vehicle. Furthermore the environment detection function is configured to detect the environment (e.g., type of road) in which the vehicle is currently running, as one of a plurality of predetermined running environments, and the adjustment function is configured to perform the aforementioned adjustment (of the threshold value or of the person probability) in accordance with the detected running environment.

Thus from that aspect of the invention, for example when the vehicle carrying the person detection apparatus is running on a road which is for use by both persons and vehicles, so that there is a relatively high likelihood that a detected target object may be a person, and/or is running on part of a road which has a history of a large number of accidents between persons and vehicle, such information concerning the environment of the vehicle can be applied to render it easier for a target object to be judged as being a person. That is, when the vehicle is running in an environment in which there is a relatively high likelihood that a target object may be a person, the aforementioned threshold value is reduced, or the calculated value of person probability is increased.

In that way the invention increases the reliability of detecting a target object that is a person, by employing environmental information to more effectively utilize information acquired from conventional types of apparatus that are commonly installed in a vehicle for target object detection (e.g., radar apparatus and/or video camera or other imaging device). The environmental information may for example be acquired from a vehicle navigation apparatus, such as is now commonly installed in vehicles.

From another aspect, the invention provides a functioning control apparatus installed in a vehicle, for controlling functioning of a crash absorption device of the vehicle, with the crash absorption device being operable for absorbing an impact of a collision between the vehicle and a person. Such a functioning control apparatus comprises a person detection apparatus according to the present invention as described hereinabove, for distinguishing whether or not a target object is a person (i.e., when it is detected that there is a danger of imminent collision between the target object and the vehicle) and functioning control function, configured to enable functioning of the crash absorption device when the person detection apparatus judges that the target object is a person, and to inhibit that functioning when the person detection apparatus judges that the target object is an object other than a person.

By applying a person detection apparatus according to the present invention in that manner, it becomes possible to more reliably prevent erroneous activation of a crash absorption device when a collision occurs between the vehicle carrying the person detection apparatus and a target object that is not a person.

Such reliability of preventing erroneous activation is especially important when the crash absorption device is an external airbag, since it is not possible to re-use a vehicle airbag once it has been deployed.

The invention is not limited to the case of a single crash absorption device. Furthermore it should be noted that the term “crash absorption device” is used herein with the general significance of any equipment of a vehicle which may be activated in a manner for alleviating the effects of a collision between the vehicle and a person.

From another aspect, the invention provides a crash absorption apparatus installed on a vehicle, configured to acquire information expressing at least a velocity of the vehicle and a position of a target object with respect to a motion direction of the vehicle. Such a crash absorption apparatus comprises a crash absorption device (such as an external airbag as described above) operable for absorbing an impact of a collision between the vehicle and a person, and includes an impact calculation function for calculating a collision time interval, i.e., the predicted interval that will elapse until the vehicle collides with the target object. The calculation is based upon the detected position of the target object (relative to the local vehicle) and the velocity of the local vehicle.

The crash absorption apparatus further includes a functioning setting function according to the present invention as described hereinabove, for judging whether or not a detected target object is a person, i.e., so that functioning of the crash absorption apparatus is enabled only when the target object is judged to be a person, and is otherwise inhibited.

The crash absorption apparatus further includes a crash absorption control function, for activating the crash absorption device only under when the functioning of that device is enabled by the functioning setting means and also the collision time interval is less than a predetermined interval (i.e., a minimum interval that would be required to avoid the collision). In any other case, functioning of the crash absorption device is inhibited, even if collision with a target object is imminent.

### BRIEF DESCRIPTION OF THE DRAWINGS

FIG. 1 is a block diagram showing the general configuration of an embodiment of a PCS;

FIG. 2 is a flow diagram of a crash alleviation processing routine that is executed by the embodiment;

FIG. 3 is a flow diagram of a functioning setting processing routine, which is part of the crash alleviation processing;

FIG. 4 is a flow diagram of a person probability computation processing routine, which is part of the functioning setting processing;

FIG. 5 is a flow diagram of a threshold value computation processing routine, which is part of the functioning setting processing;

FIG. 6 is a table showing examples of statistics concerning rates of vehicle/person accidents during daytime and night times; and

FIGS. 7 and 8 are graphs showing relationships between values of height and width of a target object and coefficients that are used in calculating a person probability value.

### DESCRIPTION OF PREFERRED EMBODIMENTS

### Overall Configuration of Embodiment

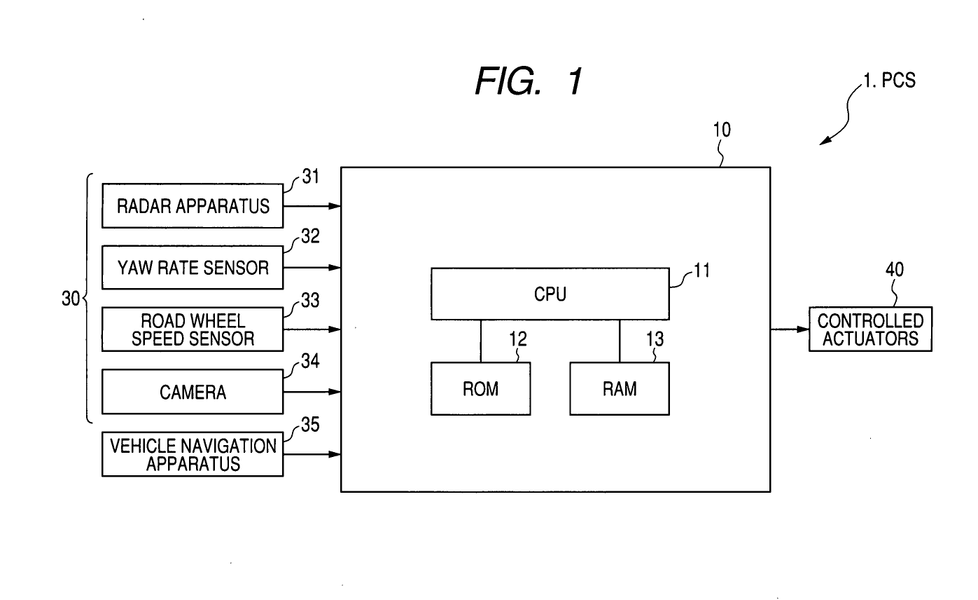

FIG. 1 is a block diagram showing the general configuration of an embodiment of a pre-crash safety system (abbreviated in the following to PCS), designated by numeral 1, which is installed in a vehicle (referred to herein as the local vehicle). The PCS 1 is provided with a detection function for detecting when a collision between the local vehicle and a person (e.g., pedestrian or cyclist) is imminent, and a crash absorption function for acting to reduce the impact of the collision, to thereby reduce the extent of injury to the person involved.

As shown in FIG. 1, the PCS 1 includes a crash absorption controller 10, and a set of devices referred to herein as the sensor devices 30, which acquire information concerning external objects and the speed, etc., of the local vehicle. The PCS 1 also includes a vehicle navigation apparatus 35 and a set of controlled actuators 40. The sensor devices 30 include a radar apparatus 31, a yaw rate sensor 32, a road wheel speed sensor 33, and a camera 34. The radar apparatus 31 detects any object (i.e., other vehicle, stationary obstacle, pedestrian) that is located in the path of the local vehicle as a target object, and derives the position (relative to the local vehicle) of such a target object, i.e., measures the distance of such a target object.

The yaw rate sensor 32 detects the yaw rate of the local vehicle, while the road wheel speed sensor 33 detects the rotation speed of the vehicle road wheels. The camera 34 of this embodiment is a video camera, disposed to capture successive images of a region ahead of the local vehicle (i.e., as respective frames of image data).

The detection results obtained by the sensor devices 30 are supplied to the crash absorption controller 10.

The radar apparatus 31 is a known type of vehicle-use radar apparatus, which periodically (e.g., once every 100 ms) performs an operation for detecting to any target object and measuring the distance of a detected target object, by transmitting radar waves and obtaining information based on resultant reflected waves that are received from a target object.

The vehicle navigation apparatus 35 detects the current location of the local vehicle, and environmental parameters of the vehicle, where the term “environmental parameters” signifies information concerning environmental conditions in which the local vehicle is currently running, such as the type of road on which the vehicle is travelling (e.g., freeway, city street, etc.). The environmental parameters may also specify the relative frequency of traffic accidents on the road on which the vehicle is currently running (i.e., derived beforehand based on recorded traffic accident statistics). The vehicle navigation apparatus 35 includes a display section (not shown in the drawings) which displays detection information such as a map of the current location of the vehicle. The vehicle navigation apparatus 35 receives requests that are transmitted from the crash absorption controller 10 and other apparatus units, and responds by transmitting the requisite information to the requesting apparatus.

In particular, with this embodiment, the vehicle navigation apparatus 35 responds to requests from the crash absorption controller 10 for information concerning environmental conditions of the local vehicle.

The crash absorption controller 10 is configured as a usual type of microcomputer which includes a CPU 11, ROM 12, RAM 13, etc, and which operates under a control program that is stored in the ROM 12, in accordance with detection results obtained by the sensor devices 30. The crash absorption controller 10 thereby executes processing for implement various functions, including crash absorption control processing, etc., as described hereinafter, and controls the controlled actuators 40 in accordance with the processing results. The severity of injuries caused by a collision between the local vehicle and a person can thereby be reduced.

With this embodiment, the controlled actuators 40 include actuators for activating an external airbag, and for opening the vehicle hood such as to enable deployment of that airbag outward from the interior of the hood, forward of the vehicle. The latter function is generally referred to as an “active hood”. Actuators are also provided which are controlled to operate the brakes, steering mechanism, and seat belt mechanisms of the local vehicle appropriately, when a collision is imminent. However the present invention is concerned with the components specifically for alleviating a collision with a person, so that “controlled actuators 40” as used in the following is to be understood as referring to the actuators of the external airbag and the active hood mechanism of this embodiment.

### Processing Executed by the Embodiment

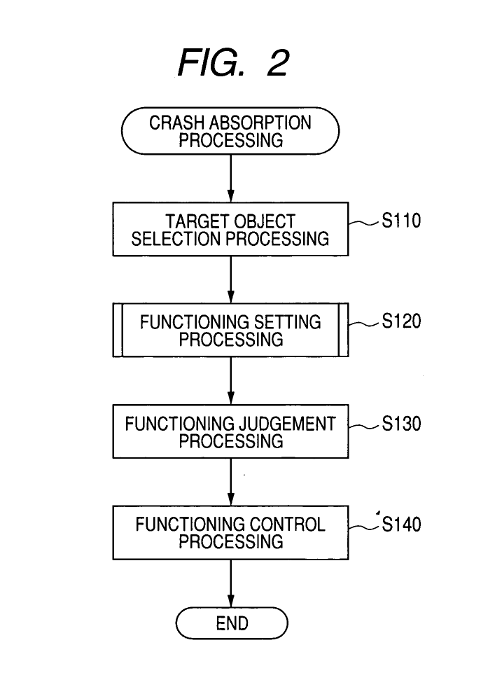

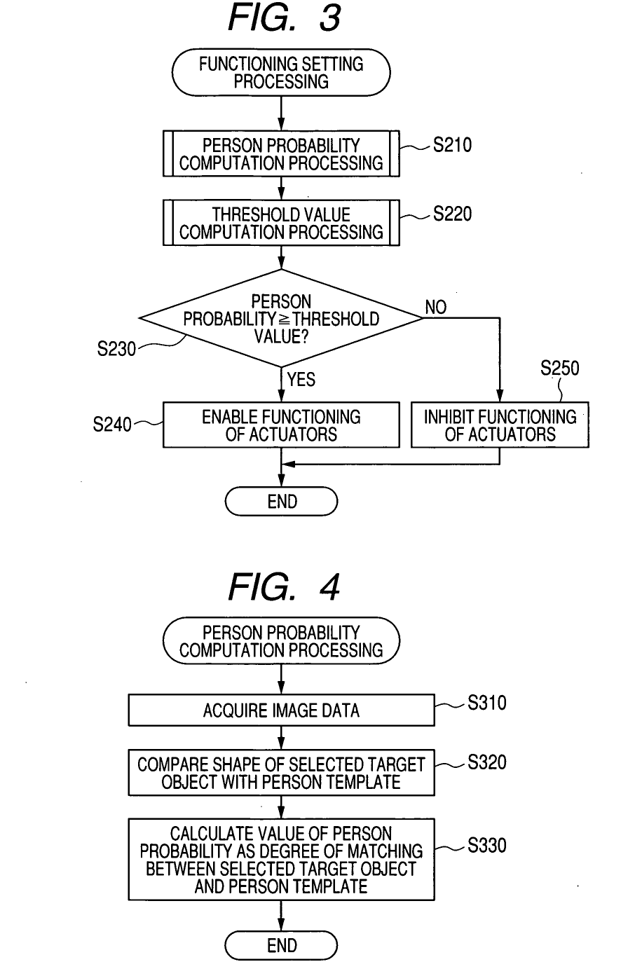

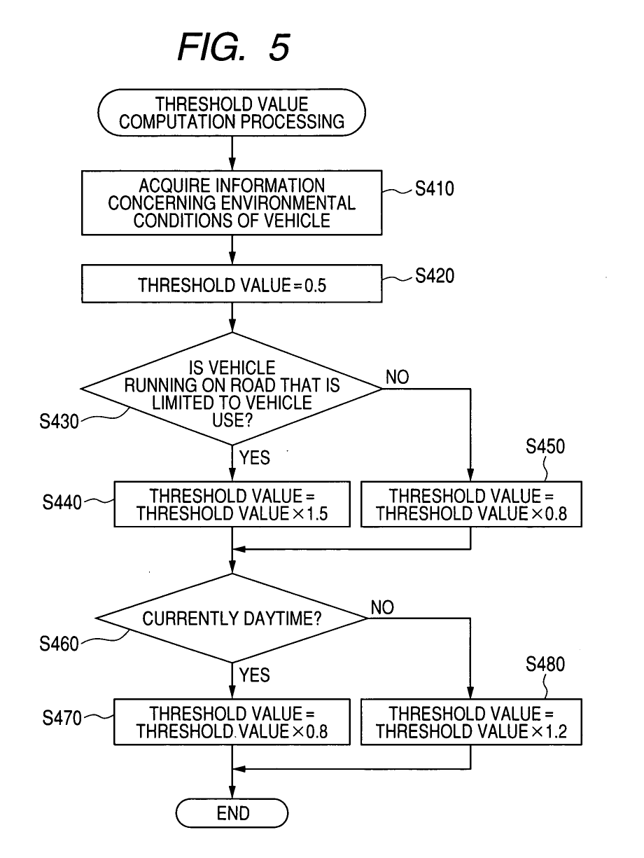

FIG. 2 is a flow diagram of an impact absorption processing routine that is repetitively executed by the CPU 11 of the crash absorption controller 10. FIG. 3 is a flow diagram of a functioning setting processing routine, which forms part of the impact absorption processing. FIG. 4 is a flow diagram of a person probability computation processing routine, which forms part of the functioning setting processing routine. FIG. 5 is a flow diagram of a threshold value computation processing routine, which forms part of the functioning setting processing routine. Each of these processing routines is executed by the crash absorption controller 10.

With this embodiment, the impact absorption processing begins to be periodically executed with a fixed period (e.g., once every 50 ms) after the ignition switch of the local vehicle is operated. As shown in FIG. 2, the impact absorption processing routine consists of a target object selection processing step (S110), a functioning setting processing step (S120), a functioning judgement processing step (S130), and a functioning control processing step (S140).

The target object selection processing of step S110 is performed to detect any target object, i.e., an object located in the motion path of the local vehicle. In this processing, detection results obtained by the radar apparatus 31 and by the camera 34 are respectively acquired, and a decision is made as to whether there is a target object for which there is a possible danger of collision, based upon these detection results. If such an object is detected, processing is executed for estimating the motion path of that object and for estimating its speed with respect to the local vehicle, etc. The results of this processing are used to select any target object for which collision with the local vehicle is imminent.

In the functioning setting processing of step S120, a decision is made (if a target object has been selected in step S110) as to whether the selected target object is a person. If the selected target object is judged to be a person, then information which expresses permission for operation of the controlled actuators 40 is stored in the RAM 13. However if a selected target object is not judged to be a person, then information is stored in the RAM 13 for inhibiting activation (functioning) of the controlled actuators 40. The operating setting processing is described in greater detail hereinafter.

In the functioning judgement processing of step S130, a decision is made as to whether a time point has been reached at which operation of the controlled actuators 40 is to be commenced. With this embodiment there are a plurality of controlled actuators 40, and hence this processing is executed respectively separately for each of these. If it is judged that a time point has been reached for activation of a specific one of the controlled actuators 40, an activation command is issued, corresponding to that specific actuator.

More specifically, based upon the estimated route and relative velocity of the selected target object (derived from the target object selection processing), an estimate is made of the time which will elapse until collision will occur between the selected target object and the local vehicle. That estimated elapsed time interval is referred to in the following as the collision interval. If the collision interval is less than an estimated minimum amount of time that would be required to avoid the collision, it is determined that the controlled actuators 40 are to be set in operation (at respective appropriate timings, as described above).

In the functioning control processing of step S140, if the aforementioned information which expresses permission for activation of the actuators has been stored in the sensor devices 30 by the processing of step S120, and it is determined (by the processing of step S130) that functioning of the controlled actuators 40 is to be commenced, then commands are issued for commencing this functioning.

However if it is found that the information which expresses inhibition of activating the controlled actuators 40 is held stored in the sensor devices 30 at that time, then commands for commencing functioning are not transmitted to the controlled actuators 40, irrespective of the results obtained in the functioning judgement processing of step S130.

The functioning setting processing (step S120) will be described in more detail in the following. In this processing, as shown in FIG. 3, person probability processing is first executed for a selected target object (step S210). In this processing, as shown in FIG. 4, firstly a captured image (containing the selected target object) is acquired from the camera 34 (step S310). The shape of the target object (as it appears in the captured image) is then compared (step S320) with one or more templates which have been stored beforehand in the ROM 12 for use in pattern matching. The templates correspond to possible shapes (external forms) of persons.

The degree of matching between the selected target object and the templates is then calculated (step S330). The size of the target object is also calculated. In this size calculation, the distance of the selected target object from the local vehicle (obtained by the radar apparatus 31) is acquired. Based on size dimensions (e.g., height and/or width) of the target object with respect to the captured image, the distance of the target object (obtained by the radar apparatus 31), and the imaging characteristics of the camera 34 (image sensor parameters, focal length of lens, etc., one or more actual size dimensions of the target object are calculated.

Each target object which is outside a predetermined range of possible sizes of a person (e.g., range of possible values of height or width) is then excluded from further consideration. For any remaining target object, the degree of matching to the templates is obtained, as a numeric value which increases in accordance with increased probability that the target object is a person. This numeric value is referred to herein as the person probability, which with this embodiment is within the range 0 to 1. When the processing of step S330 is completed, the person probability computation processing is ended. The processing of FIG. 3 is then returned to, and threshold value computation processing is performed (step S220). This processing is executed to obtain a threshold value for use in judging whether a selected target object is a person. Firstly as shown in FIG. 5, the running environment of the local vehicle is acquired (step S410).

The term “running environment” signifies conditions relating to the local vehicle at the current point in time, including the traffic circumstances in which that vehicle is currently operating, the time of day, the day of the week, the date, the type of road on which the vehicle is running, the width of the road, whether it is currently daytime or night, the weather, the road conditions, whether there are white lines (lane markers) on the road, etc. (Specifically, “daytime” as used herein signifies “during the hours of daylight”, while “night” signifies “during the hours of darkness”). This information is acquired from the vehicle navigation apparatus 35. It would be possible to perform the threshold value computation processing by using all of such running environment information. However for simplicity of description it is assumed in the following that the threshold value is set based only upon information specifying the type of road (i.e., information indicating whether or not the local vehicle is running on a road which is limited to use by vehicles) and information specifying whether it is currently daytime or night.

Compensation factors (to be applied to the threshold value as described in the following) are stored beforehand in the ROM 12. Each compensation factor is stored together with a corresponding information item specifying a particular type of road, or specifying daytime or night operation.

On completion of step S410, a predetermined initial value of 0.5 is set for the threshold value and is stored in the RAM 13 (step S420). A decision is then made as to whether the local vehicle is currently running on a road that is limited to use by vehicles (step S430). If that is the case (YES decision in step S430) then the threshold value held in the RAM 13 is multiplied by a compensation factor of 1.5 and the result is stored in the RAM 13 (step S440) to replace the previous threshold value. If the vehicle is judged to be running on a road that is not limited to use by vehicles (NO decision in step S430) then the threshold value held in the RAM 13 is multiplied by a compensation factor of 0.8 and the result is stored in the RAM 13 to replace the previous threshold value (step S450).

Next, a decision is made as to whether it is currently daytime or night (step S460). If it is currently daytime (YES in step S460) then the threshold value held in the RAM 13 is multiplied by a compensation factor of 0.8 and the result is stored in the RAM 13 to replace the previous threshold value (step S470), and the threshold value computation processing is then ended. If the local vehicle is judged to be currently running at night (NO decision in step S460) then the threshold value held in the RAM 13 is multiplied by a compensation factor of 1.2 and the result is stored in the RAM 13 to replace the previous threshold value (step S480). The threshold value computation processing is then ended.

On completion of the threshold value computation processing, the processing of FIG. 3 is returned to. Firstly (S230), the person probability which was calculated in step S210 is compared with the threshold value that was calculated in step S220. If the person probability exceeds the threshold value (YES in step S230) then information specifying permission for activation of the controlled actuators 40 is stored in the RAM 13 (step S240), and the functioning setting processing is then ended.

If the person probability does not exceed the threshold value, then information for inhibiting activation of the controlled actuators 40 (refusal of permission) is stored in the RAM 13 (step S250), and the functioning setting processing is then ended.

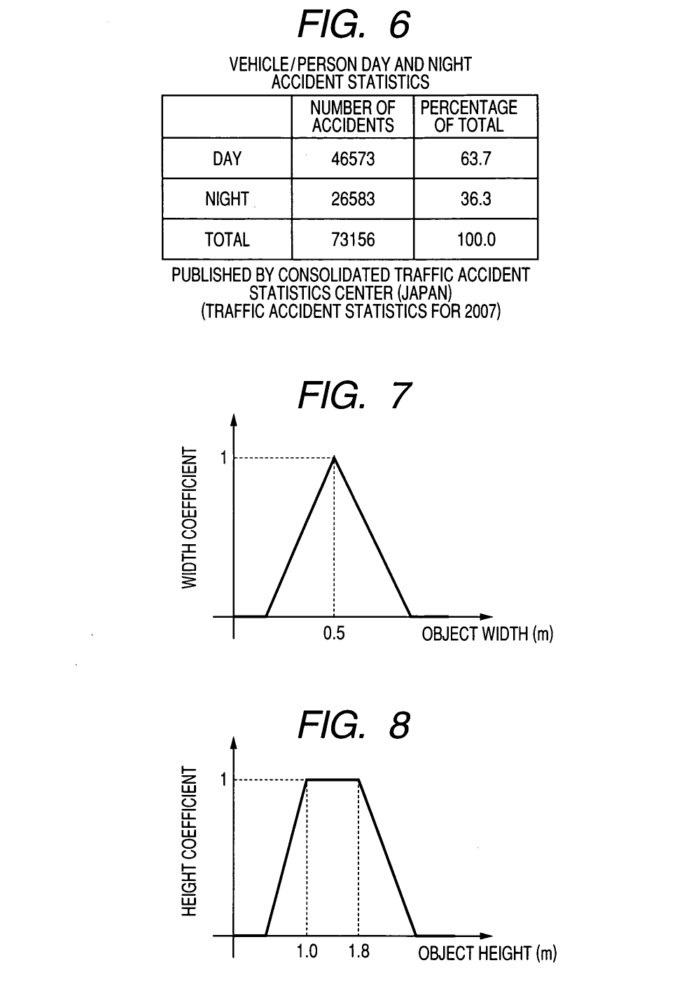

Steps S460 to S480 of FIG. 5 serve to modify the threshold value in accordance with whether the local vehicle is currently being driven during daytime or during the night. The reason for this is illustrated in FIG. 6, which shows examples of the relative rates at which accidents (collisions between vehicles and persons) occur during the daytime hours and during the night hours, respectively. As illustrated by FIG. 6, during daytime hours there is a relatively high probability that persons (pedestrians or cyclists) will be upon a road. Hence, during daytime driving of the local vehicle, it is ensured with this embodiment that a target object will be more readily judged to be a person than is the case when driving during the night hours, i.e., by lowering the threshold value.

Furthermore when the local vehicle is driving on a road which is exclusively for use by vehicles, there is a relatively low probability that a detected target object will be a person. Hence when driving along such a road, it is ensured that a target object will be less readily judged to be a person, by comparison with the case of driving along some other type of road. This is achieved (step S440 of FIG. 5) by increasing the threshold value.

### Effects Obtained by Embodiment

With the embodiment described above, the CPU 11 of the crash absorption controller 10 performs impact absorption processing for reducing the effects of a collision between the local vehicle and a person, as follows. When a target object is selected as being in danger of collision with the local vehicle, the apparatus estimates the time which will elapse until the collision occurs. In addition, a judgement is made as to whether the selected target object is a person. Based on the judgement result and the estimated time to the collision, a determination is made as to whether to operate the controlled actuators 40, for reducing the effects of the collision when the local vehicle collides with a person. Specifically, if the selected target object is judged to be a person, and in addition it is judged that the time which will elapse until the collision is shorter than a minimum duration (i.e., is less than the minimum amount of time that would be required for avoiding the collision), then the controlled actuators 40 are activated.

In particular, in determining whether a selected target object is a person, the CPU 11 calculates a person probability value for that target object, which is based upon the degree of matching (degree of closeness) between one or more parameters relating to the external appearance of a person (e.g. maximum height that is compatible with a person, etc.) and the detection results obtained from the radar apparatus 31 and camera 34.

In addition, the CPU 11 acquires detection results from the yaw rate sensor 32 and the vehicle navigation apparatus 35 which are indicative of the environmental conditions at the time of detecting the selected target object, i.e., the conditions under which the local vehicle is operating (such as whether the local vehicle is running on a road which is exclusively for use by vehicles, as described above). Based on this environmental information and upon the calculated person probability, the CPU 11 selects from a plurality of compensation factors which have been stored beforehand in a ROM, with each compensation factor having been stored linked to a corresponding environment parameter (night operation, daytime operation, operation on a road which is limited to use by vehicles, etc.). With this embodiment as described above, an initially determined (default) threshold value is modified by applying the compensation factors which correspond to the environment parameters under which the local vehicle is operating at the time of detecting the selected target object.

The calculated person probability is then compared with the resultant modified threshold value. If the person probability exceeds that threshold value, then the selected target object is judged to be a person.

It will be understood that it would be equally possible to use a fixedly predetermined threshold value, and instead apply the compensation factors to modify the person probability which has been calculated for the selected target object. The resultant modified person probability would then be compared with the fixed threshold value, to thereby judge whether the target object is a person.

In either case, the same effect is obtained, i.e., when the environment parameters of the local vehicle indicate that there is a relatively high probability that a selected target object (having a danger of collision) may be a person, then the threshold value or the person probability corresponding to that target object is modified such as to increase the likelihood that the target object will be judged to be a person (i.e., by decreasing the threshold value, or by increasing the person probability).

Conversely, if the environment parameters of the vehicle indicate that there is a relatively low probability that a selected target object is a person (e.g., as when the local vehicle is running on a road which is exclusively for vehicle use, during daytime hours), then the threshold value or the person probability is modified such as to decrease the likelihood that the target object will be judged to be a person (i.e., by increasing the threshold value, or by reducing the person probability).

In that way, it becomes possible to more accurately discriminate between a target object which is a person and other types of object. It can thereby be more reliably ensured that the controlled actuators 40 will be activated only in the specific case in which collision with a person becomes unavoidable.

With the above embodiment as described above, the CPU 11 of the PCS 1 calculates a person probability based upon parameters relating to a target object, which are derived from detection results (distance data and image data) obtained by the radar apparatus 31 and the camera 34. In addition the CPU 11 acquires environment condition information relating to the local vehicle from the yaw rate sensor 32, the vehicle navigation apparatus 35, etc, derives a compensation factor for modifying the threshold value (or the calculated person probability) based upon that information, and modifies the threshold value (or person probability) accordingly, prior to performing a comparison between the person probability and threshold value, for judging whether or not a specific target object is a person.

It can thus be understood that the invention enables equipment which is normally installed in a motor vehicle (vehicle navigation apparatus, etc.) to be used for obtaining the current environmental conditions in which the vehicle is running, and to use that obtained information for readily determining the probability that a person is located in the motion path of the vehicle.

Furthermore, the CPU 11 of the above embodiment applies compensation to the threshold value by applying a compensation factor which is based upon the frequency with which accidents between people and vehicles have occurred in the past, in environmental conditions (i.e., type of road, time of day, etc.) which are similar to the current environmental conditions in which the local vehicle is running. Specifically, if the local vehicle is running in an environmental condition in which a large number of person/vehicle accidents have occurred in the past, this is judged as indicating a relatively high probability that a person may be located in the motion path of the vehicle.

Hence with the above embodiment, when the local vehicle is running in such an environmental condition in which there is a history of a high frequency of person/vehicle accidents, the threshold value (or person probability) is modified such as to increase the likelihood that a detected target object will be judged to be a person. More reliable detection of persons located in the motion path of the vehicle can thereby be achieved.

In addition with the above embodiment, the CPU 11 acquires detection results from the vehicle navigation apparatus 35, indicating the type of road on which the local vehicle is currently running. If that road is exclusively for use by vehicles, then it is made more difficult for a target object to be judged as being a person (i.e., the threshold value is increased, or person probability is decreased), by comparison with the case in which the road is not exclusively for use by vehicles.

In that way, when the local vehicle is running on a road where there should (in principle) be no pedestrians, it is made less likely that a target object will be judged to be a person. Hence, the possibility of erroneous detection of objects other than persons can be substantially reduced.

Furthermore with the above embodiment, the CPU 11 applies a target object detection method which utilizes the shape of a target object, which is acquired by image processing applied to an image that is captured by the camera 34 (which captures images of a region which may contain relevant target objects). In addition, the target object detection method uses the distance value of a target object, which is acquired by the radar apparatus 31. The person probability is then calculated based on the shape and distance information thus acquired.

Based upon the distance of a target object and the size of the target object as it appears in a captured image, the actual size of the target object is estimated, as described above. The accuracy of discriminating between persons and other types of object can thereby be increased, by utilizing this actual size information. In particular, objects which differ significantly in size from the possible range of sizes of a person can be quickly excluded from consideration.

### Alternative Embodiments

The present invention is not limited to the above embodiment, and various other embodiments or modifications of the above embodiment may be envisaged.

For example with the above embodiment, the shape of a target object is derived based on image processing of images that are obtained by the camera 34. However if the radar apparatus 31 is configured to measure the height and width of a target object, and not only the distance, then use of the camera 34 could be omitted. In that case, the size of a target object would be estimated based upon the height and width values of the object as obtained by the radar apparatus 31.

FIGS. 7 and 8 show examples of the relationships between values of width and height of a target object (as detected by the radar apparatus 31) and coefficients for use in calculating the person probability. As shown in FIGS. 7, 8, when the width of a target object is 0.5 m and the height is within the range 1.0 to 1.8 m, there is a maximum probability that the target object is a person. Specifically, the person probability value for a target object is calculated by multiplying each of the width coefficient (obtained by applying the detected width value of that target object to the relationship shown in FIG. 7) and the height coefficient (obtained by applying the detected height value of the target object to the relationship shown in FIG. 8) by an appropriate predetermined constant, e.g., 0.5, and summing the results of these multiplications.

It can thus be understood that, the more the width of a target object varies from 0.5 m, the smaller will become the person probability. Similarly, the more the height of the target object varies from the range of 1.0 to 1.8 m, the smaller will become the person probability.

As a further alternative, it would be possible to utilize both a radar apparatus as described above, to derive a first person probability, and also to apply an imaging device (e.g., video camera) and image processing to derive a second person probability, and to combine these person probabilities to obtain a final person probability (i.e., by multiplying each of the first and second person probabilities by a suitable constant such as 0.5, and summing the results of the multiplications).

Furthermore it would also be possible to apply compensation to the aforementioned threshold value in accordance with the length of time for which a selected target object continues to be judged to be a person. Alternatively, (when a plurality of different methods are applied respectively separately, to judge whether a detected target object is a person) the compensation could be applied to the threshold value in accordance with the total number of methods for which a decision has been reached that the target object is a person.

In addition as described hereinabove, it is possible to apply such compensation to modify a calculated person probability value, and to compare the resultant modified person probability with a predetermined threshold value, instead of applying compensation to the threshold value as with the above embodiment.

Furthermore with the first embodiment above, data are stored beforehand in a ROM, which relate each of respective compensation factors (to be applied in compensating a threshold value or person probability) to a corresponding one of a plurality of environmental condition parameters (such as respectively different types of road). However it would be equally possible to store data in a ROM which relate each of respective predetermined person probability values to a corresponding one of a plurality of environmental condition parameters.

In that case, when such a person probability value is read out from the ROM in accordance with a current environmental condition of the local vehicle, a compensation factor can be calculated based on that person probability value. The compensation factor can then be applied (for compensating a threshold value or person probability) as described for the first embodiment.

It should further be noted that with the present invention, variation of the threshold value (or increasing of the person probability) may be performed in a stepwise manner as with the above embodiment, or could be executed in a continuous manner.

What is claimed is:

1. A person detection apparatus comprising
target object parameter detection means configured to detect at least one target object parameter relating to an external appearance of a target object,
person probability computation means configured to calculate a person probability as a numeric value, said person probability expressing a degree of matching between said target object parameter and a predetermined person parameter relating to a typical external appearance of a person,
environment detection means configured to detect at least one environmental condition relating to an environment in which said target object parameter is detected, at a time of said detection of the target object parameter, and
person judgement means configured to compare said person probability with a threshold value and to judge that said target object is a person when said person probability exceeds said threshold value;
wherein said person detection apparatus comprises compensation means configured to adjust a predetermined one of said threshold value and said person probability in accordance with said detected environmental condition, and wherein said adjustment is executed such as to render it increasingly easier for said target object to be judged to be a person, in accordance with increasing probability that persons will be present in said environment, as indicated by said environmental condition.

2. A person detection apparatus according to claim 1, comprising a memory having data stored therein relating respectively different ones of said environment conditions to corresponding values of a compensation factor, and wherein said compensation means is configured to execute said compensation by acquiring from said memory a one of said compensation factor values corresponding to said environmental condition that is detected by said environmental condition detection means, and to apply said compensation factor to said predetermined one of the threshold value and person probability.

3. A person detection apparatus according to claim 2, wherein
said compensation means is configured to set said compensation factor to be smaller than one, when said detected environmental condition corresponds to a relatively high probability that an arbitrary target object will be a person, and to multiply a predetermined threshold value by said compensation factor to obtain a compensated threshold value, and
said person judgement means is configured to compare said person probability with said compensated threshold value.

4. A person detection apparatus according to claim 1, wherein
said compensation means is configured to set a compensation factor to be greater than one, when said detected environmental condition corresponds to a relatively high probability that an arbitrary target object will be a person, and to multiply said person probability by said compensation factor to obtain a compensated person probability, and
said person judgement means is configured to compare said compensated person probability with a predetermined threshold value.

5. A person detection apparatus according to claim 1, comprising a computer and a data storage device having a control program stored beforehand in said data storage device, wherein respective functions of said person probability computation means, said person judgement means, and said compensation means, are implemented by processing steps executed by said computer, operating under said control program.

6. A person detection apparatus according to claim 1, wherein
said person detection apparatus is installed in a vehicle, and comprises target object selection means configured for selecting a specific target object from one or more detected objects, as a body which is located at a position coinciding with a direction of motion of said vehicle, and
said environment detection means is configured to detect an environment in which said vehicle is currently running, as one of a plurality of predetermined running environments, and said adjustment means is configured to perform said adjustment in accordance with said detected running environment.

7. A person detection apparatus according to claim 6, wherein said target object selection means comprises at least one of a radar apparatus and an imaging apparatus respectively installed in said vehicle for deriving information indicative of said target object position, and position information processing means configured for processing said information to effect said selection of said specific target object.

8. A person detection apparatus according to claim 7, comprising a computer and a data storage device having a control program stored beforehand in said data storage device, wherein respective functions of said position information processing means are implemented by processing steps executed by said computer, operating under said control program.

9. A person detection apparatus according to claim 6, comprising a memory having relationship data stored beforehand therein, said relationship data expressing a relationship between a plurality of respectively different environmental conditions and respectively corresponding values of a compensation factor, said compensation factors established beforehand based upon information including numbers of accidents between persons and vehicles which have occurred in the past under said corresponding environmental conditions,
wherein said compensation means is configured to apply data expressing said detected running environment to said relationship data to obtain a corresponding value for said compensation factor, and to utilize said corresponding compensation factor value for implementing said compensation.

10. A person detection apparatus according to claim 9, wherein said respectively different running environments comprise a plurality of respectively different types of road.

11. A person detection apparatus according to claim 10, wherein
said respectively different types of road include at least a type of road that is limited to use by vehicles, and a type of road which is for general use, and
a compensation factor value corresponding to said type of road limited to use by vehicles is predetermined for effecting said compensation such as to render it more difficult for said target object to be judged to be a person than is the case for a compensation factor value corresponding to said type of road which is for general use.

12. A person detection apparatus according to claim 1, wherein said target object parameter detection means comprises
an imaging device configured to capture image data expressing an image of a region containing said target object,
image processing means configured to process said image data to obtain data relating to an external shape of said target object, and
a distance measurement device configured to transmit waves towards said target object and receive resultant reflected waves from said target object, and to measure a distance of said target object based upon said reflected waves;
wherein said person probability computation means is configured to calculate said person probability for said target object based upon respective results obtained from said image processing means and said distance measurement device, in combination.

13. A person detection apparatus according to claim 1, wherein
said target object parameter detection means comprises a radar apparatus configured to measure at least one size dimension of said target object, and
said person probability computation means is configured to calculate said person probability for said target object based upon comparing said measured size dimension with predetermined statistical information concerning said size dimension in relation to persons.

14. A person detection apparatus according to claim 13, wherein
said radar apparatus is configured to measure a height and a width of said target object, and
said person probability computation means is configured to calculate said person probability for said target object based upon comparing said measured height and width with predetermined statistical information relating to heights and widths of persons.

15. A functioning control apparatus installed in a vehicle, for controlling functioning of a crash absorption device of said vehicle, said crash absorption device configured to be operable for absorbing an impact of a collision between said vehicle and a person, the functioning control apparatus comprising
a person detection apparatus for distinguishing whether or not a target object is a person, when it is detected that there is a danger of imminent collision between said target object and said vehicle, and
functioning control means configured to enable said functioning of said crash absorption device when said person detection apparatus judges that said target object is a person, and to inhibit said functioning when said person detection apparatus judges that said target object is an object other than a person;
wherein said person detection apparatus comprises a person detection apparatus as claimed in claim 1.

16. A functioning control apparatus according to claim 15, comprising a computer and a data storage device having a control program stored beforehand in said data storage device, wherein functions of said functioning control means are implemented by processing steps executed by said computer, operating under said control program.

17. A crash absorption apparatus installed on a vehicle, configured to acquire information expressing at least a speed of said vehicle and a position of a target object with respect to a motion direction of said vehicle, and comprising
a crash absorption device operable for absorbing an impact of a collision between said vehicle and a person,
impact calculation means configured to calculate a collision time interval as a predicted interval until a collision will occur between said vehicle and said target object, said calculation based upon said detected position and speed,
functioning setting means configured to judge whether or not said target object is a person, to enable a functioning of said crash absorption apparatus when said target object is judged to be a person, and to inhibit said functioning when said target object is judged to be an object other than a person, and
absorption control means configured to initiate said functioning of said crash absorption device only when said functioning is enabled by said functioning setting means and also said collision time interval is less than a predetermined interval required to avoid said collision, and to otherwise inhibit said functioning;
wherein said functioning setting means comprises a functioning control apparatus as claimed in claim 15.

18. A crash absorption apparatus according to claim 17, comprising a computer and a data storage device having a control program stored beforehand in said data storage device, wherein respective functions of said impact calculation means and said absorption control means are implemented by processing steps executed by said computer, operating under said control program.
